(19) United States
(12) Patent Application Publication
(10) Pub. No.: US 2015/0220939 A1
(43) Pub. Date: Aug. 6, 2015

(54) Monetization Channel Exchange

(71) Applicant: Google Inc., Mountain View, CA (US)

(72) Inventor: Bernard Chiew Hung Tay, Singapore (SG)

(73) Assignee: Google Inc., Mountain View, CA (US)

(21) Appl. No.: 14/169,809

(22) Filed: Jan. 31, 2014

(51) Int. Cl. G06Q 30/02

(52) U.S. Cl. CPC G06Q 30/0201

(57) ABSTRACT

The present disclosure provides a monetization channel exchange system for selecting and implementing a monetization channel for an application. The monetization channel exchange system may identify a plurality of monetization channels and determine a projected revenue for an application based on each of the plurality of monetization channels. A score may be generated for each channel of the plurality of monetization channels based on the projected revenue for the channel. Next, a first monetization channel of the plurality of monetization channels may be selected based on the score of the first monetization channel. As a result, the first monetization channel may be implemented for the application.

### BACKGROUND

There are multiple ways for an application developer to monetize an application. For example, an application developer may monetize an application based on advertisements, in-app-purchases, one-time-purchase (e.g., download fee), incentive-based ad placement, and other monetization channels. Identifying the best monetization channels to use for monetizing a specific application can be difficult to manage and may change over time, for example as an application becomes more or less popular.

### BRIEF SUMMARY

According to an embodiment of the disclosed subject matter a method may include identifying a plurality of monetization channels and determining a projected revenue for an application based on each of the plurality of monetization channels. Next, a score may be generated for each channel of the plurality of monetization channels based on the projected revenue for the channel. A first monetization channel of the plurality of monetization channels may be selected based on the score of the first monetization channel. As a result, the first monetization channel may be implemented for the application.

An implementation of the disclosed subject matter provides a system including a processor configured to identify a plurality of monetization channels and determine a projected revenue for an application based on each of the plurality of monetization channels. A score may be generated for each channel of the plurality of monetization channels based on the projected revenue for the channel. Next, a first monetization channel of the plurality of monetization channels may be selected based on the score of the first monetization channel. As a result, the first monetization channel may be implemented for the application.

Implementations of the disclosed subject matter provide a centralized monetization exchange system for monetization of an application. The disclosed system may automatically select and implement a monetization channel for an application after it has been released, which may result in improved revenue generation during the life of the application. Additionally, an application developer having one application or multiple applications may manage the monetization channel for each application and a different monetization channel may be implemented for each application based on unique factors for each application. Further, the monetization exchange system may automatically optimize the revenue generated by an application by monitoring and adjusting the selected monetization channel for an application over time. Additional features, advantages, and embodiments of the disclosed subject matter may be set forth or apparent from consideration of the following detailed description, drawings, and claims. Moreover, it is to be understood that both the foregoing summary and the following detailed description are examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example process according to an implementation of the disclosed subject matter.

FIG. 2 shows an example system arrangement according to an implementation of the disclosed subject matter.

FIG. 3 shows a computer according to an embodiment of the disclosed subject matter.

FIG. 4 shows a network configuration according to an embodiment of the disclosed subject matter.

### DETAILED DESCRIPTION

A developer of an application has a growing number of options to choose from when it comes to monetization of their application. In general, options for monetizing an application, i.e., monetization channels, may include placement of advertisements, in-app-purchases, one-time-purchases e.g., one-time download fees, incentive-based ads, and other monetization channels that are projected to be available in the future. Given the expanding number of monetization channels and the number of vendors (e.g., providers) of each of these monetization channels, choosing a monetization channel for an application that may maximize or achieve a desired level of revenue generated by the application can be difficult to manage by the application developer.

Typically, deciding how to monetize an application is among the first questions presented to a developer when creating a new application. In general, how to monetize an application may change during the course of the life of the application and in this case, there is currently no way for a developer to change a monetization strategy for an application once the application has been released. For example, once a developer decides to implement in-app advertising for a particular application, it may be difficult or impossible to update the application to take advantage of a new monetization channel available to the developer or to the application, such as sale of physical good via the application.

The present disclosure provides a monetization channel exchange that may allow the monetization strategy for an application to dynamically change (e.g., based on an instruction from the developer or automatically), even after the application has been released into the market and at any time throughout the life of the application. As a specific example, under current practice, when a developer wishes to present an advertisement in an application, the code for the application may be written to include instructions for how to monetize the application, such as via a specific monetization channel, at the time the application is created. For example, conventional code for an application may include instructions to show an ad such as “show_ad( ){provide_an_ad(network)}.” According to the present disclosure, the developer would not need to include specific monetization instructions at the time of writing the code for the application. Rather, the code for the application may include instructions to allow the monetization channel exchange select an appropriate monetization channel to optimize the revenue generated by the application. For example, the code for the application may include instructions to allow the exchange to select such as “monetize( ){allow_exchange_select( ){ },” effectively moving the selection of a particular monetization channel and related options to a monetization channel exchange system separate from the application. The monetization channel exchange may decide the most optimal monetization channel method to use based on an evaluation of the available monetization channels. In addition, the developer may also dynamically configure the allocation of the monetization opportunities in an application across various monetization channels.

According to the disclosed subject matter, a monetization channel exchange system provides a platform that may include a client side and a server side. The server side may provide native support to various monetization channel platforms such as ads, in-app purchases, one-time download fees, incentive-based ads, and also integration points into other already existing vendors/platforms. The client side may provide a platform where a developer can manage monetization opportunities in one or more applications based on the various available monetization channels such as ads, in-app purchases, one-time download fees, incentive-based ads, and others. Using the monetization channel exchange system, a developer may view the performance of each of the selected monetization channels, dynamically allocate monetization opportunities in an application to different monetization channels based on parametric rules or the allocation of monetization opportunities may be automatically optimized by the exchange system. In some cases, the developer may be able to view and/or manage the monetization strategy selected by the exchange system for a single application or across a portfolio of applications. As a result, the monetization channel exchange platform provides developers with a one-stop-shop for all application monetization needs.

Furthermore, an advantage of the disclosed system is that an application developer having multiple applications may manage the monetization stream for each application implementing different monetization channels for each application in one place. In addition, an application developer may be able to view the performance of each of the monetization channels and dynamically allocate particular applications to different monetization channels based on parametric rules. In some cases, the monetization exchange system may automatically optimize the revenue generated by an application by monitoring and adjusting the selected monetization channels for an application over time.

The present disclosure provides a system for dynamically selecting a monetization channel for an application. A monetization exchange system may communicate between an application provider (e.g., an application store or marketplace) and a developer of an application. For a particular application, the monetization exchange system may identify multiple monetization channels such as ads, in-app-purchases, one-time-download fees, incentive-based advertisements, and other available monetization channels. The system may evaluate each identified monetization channel based on the application and determine a projected revenue for each monetization channel. The system may then generate a score for each monetization channel based on the projected revenue. For example, a score may be higher for a particular monetization channel if the projected revenue associated with the particular monetization channel is relatively higher than the projected revenue associated with another monetization channel. Based on the quality score generated for each monetization channel, a monetization channel may be selected. For example, the system may select the monetization channel that received a threshold minimum quality score or higher. As a result, the monetization exchange system may implement the selected monetization channel. In some cases, this monetization channel may be implemented by providing an indication to an application provider of the selected monetization channel for the particular application. In some cases, the system may provide, to the application, a monetization opportunity based on the first monetization channel, as described below.

As an example, a monetization exchange system may receive a skateboard game application from an application developer. The system may identify multiple monetization channels, such as advertisements, in-app-purchases, and one-time-download fees. For each monetization channel, a projected revenue may be determined based on the application for each identified monetization channel. For example, a skateboard manufacturer may be willing to pay an application developer $10 for each skateboard sold as a result of presenting an advertisement for the skateboard manufacturer to users of the application. The probability that a user (who is presented with an advertisement for the skateboard manufacturer) will buy a skateboard may be multiplied by $10 to determine the projected revenue the publisher is likely to make over 1000 impressions of the ad being presented. This projected revenue may be used to generate a score for the advertisement monetization channel. Similarly, projected revenue values may be determined for each of the other monetization channels—in-app purchases and one-time-downloads. Based on these determined projected revenue values, a score may be generated for each of the in-app purchases and one-time-downloads monetization channels. As an example, the advertisement monetization channel may receive a score of 8, the in-app purchases monetization channel may receive a score of 4, and the one-time-downloads monetization channel may receive a score of 7. Based on the scores, the system may select the monetization channel having the highest score. As such, the system may select the advertisement monetization channel. Next, the system may implement the advertisement monetization channel for the skateboard game application by presenting, to a user of the skateboard application, an advertisement for a skateboard from the skateboard manufacturer. Systems and techniques described herein may continuously implement the most optimal monetization channel for an application based on the evaluation of the various different monetization channels. This technique may result in higher levels of revenue during the life of an application than would be possible using conventional single-channel techniques.

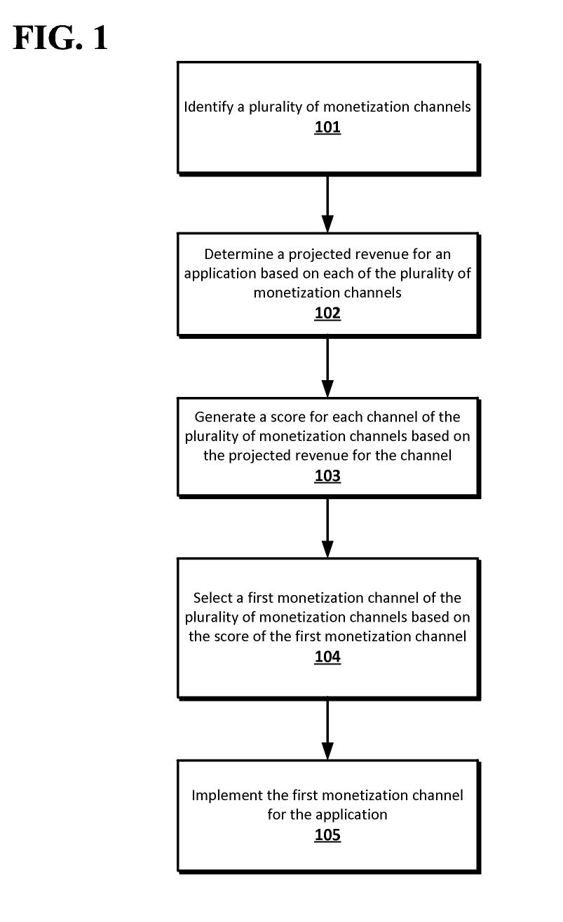

FIG. 1 shows an example process according to an implementation of the disclosed subject matter. As shown, multiple monetization channels may be identified, at 101. A projected revenue may be determined for an application based on each of the multiple monetization channels, at 102. Next, a score may be generated for each channel among the multiple monetization channels based on the projected revenue for the channel, at 103, and a first monetization channel may be selected from among the multiple monetization channels based on the score of the first monetization channel, at 104. As a result, the first monetization channel may be implemented for the application, at 105.

In general, there may be several monetization channels available in the application marketplace and the monetization exchange system may identify a portion or all of the available monetization channels. Examples of monetization channels may be advertisements, in-app purchases, one-time downloads, physical goods, and any other possible channel for generating revenue in or by an application. According to an implementation, the monetization exchange system may include native adapters for each of the identified monetization channels. For a specific monetization channel, a native adapter may allow for communication between the monetization exchange system and the vendors in the specific monetization channel. As an example, for the advertisements monetization channel, there may be, for example, 5 vendor ad networks that may offer to provide an advertisement to be presented to a user of the application. The native adapter may allow the monetization exchange system to natively communicate with each of the 5 vendor ad networks, for example the system may utilize the same application programming interface (API) as used by each of the 5 vendor ad networks to query each network for advertisements that may be presented in the application and to determine projected revenue information. As another example, the system may include a native adapter for the physical goods monetization channel and this native adapter may allow the system to communicate with the one or more vendors in the physical goods channel to determine projected revenue information and monetization content from the one or more vendors in the channel.

The monetization exchange system may determine a projected revenue for an application based on each of the identified monetization channels. In some cases, the projected revenue for an application may be an expected dollar amount received by a developer of the application upon activation (by a user) of monetization content, presented by the application to the user, based on the monetization channel. Monetization content may be any content that may be presented in an application that, if activated by a user, may result in revenue generated by the application. For example, monetization content may be an advertisement, a link to a webpage, an interface including an option to make a purchase and/or download content or purchase physical goods, and the like. Activation of monetization content by a user may be any action indicating a user's interest in monetization content presented in the application. For example, a user may activate monetization content by selecting, purchasing, downloading, and the like, monetization content presented in an application. As specific examples, the projected revenue may be the expected dollar amount (received by the developer of the application) when a user takes action on presented monetization content such as the user clicking on an ad, a user making an in app purchase, a user paying a one-time download fee, a user purchasing a physical good, and any other action that a user may take on presented monetization content.

As an example, for a particular travel review application, the monetization exchange system may identify the monetization channels advertisements, in-app purchases, one-time downloads, and physical goods. For the each of the monetization channels, the system may query the channel for monetization content relevant to a travel review application. As an example, in the advertisements channel, an airline may be interested in placing an ad in the travel review application. The system may determine that if a user of the application were to activate an ad for the airline in the application, the projected revenue may be $2. In the in-app purchases channel, a premium account may be offered to the user which may provide the user with access to exclusive travel information, and in this case, the system may determine that if a user were to purchase a premium account, the projected revenue may be determined to be $4. For the one-time downloads channel, for example, the same developer of the travel application may have released a newer version of the travel application. The developer may wish to present a link for the user to download the newer version of the application for a certain price. The system may determine that if a user of the application were to download and purchase the newer version of the application, the projected revenue may be $1. For the physical goods channel, a retailer may be interested in presenting a link to purchase luggage for a certain price. The system may determine that if a user of the application were to purchase the luggage, the projected revenue may be $5. These projected revenue values may be used to generate a score for each monetization channel.

The system may generate a score for each channel among the multiple monetization channels based on the projected revenue for the channel. In some cases, the score for each channel may be based on a probability that a user will activate presented monetization content in the channel. According to an implementation, the score for each channel may be a product of the projected revenue for the channel and a probability that a user will activate presented monetization content based on the channel. As in the example above regarding the travel review application, for the advertisements monetization channel, the system may determine that if a user of the application were to activate an ad for the airline in the application, the projected revenue may be $2. They system may also determine that the probability that a user will activate an ad for the airline in the application is 0.2. Based on the projected revenue and the probability, they system may generate a score of 0.40 (i.e., the product of the projected revenue of $2 and the probability of 0.2). Similarly, the system may generate a score for the other monetization channels—in-app purchases, one-time downloads, and physical goods. For the in-app purchases channel, the system may generate a score of 0.24 based on the projected revenue of $4 and a probability of 0.6. The system may generate a score of 0.60 for the one-time downloads channel based on the projected revenue of $1 and a probability of 0.6 that a user will download and purchase the new version of the application. For the physical goods channel, the system may generate a score of 0.10 based on the projected revenue of $5 and a probability of 0.2 that a user will purchase luggage in response to a link presented in the application. In general, a score may be any format such as a value, a position in a ranked list, a dollar amount, and any other suitable format that allows for comparison of monetization channels.

The probability that a user will activate monetization content that is presented in an application may be based on a variety of factors. For example, the probability may be based on a user activation history associated with a user. A user activation history may indicate the likelihood that a user or group of users (e.g., user of a particular application) will activate a particular monetization content based on the user's past activations of previously presented monetization content. Examples of user history may be a user's purchase history, a user's conversion rate, a user's click-through-rate, and the like. A user activation history may be specific to a particular user, to all users of a specific application, or to a set of users of the application and/or other applications, such as other applications available within a common application store or similar source. For example, the probability that a user will activate monetization content, such as purchase luggage presented in a travel review application, may be based on the particular user's activation history including past purchases, such as in a particular monetization channel. As an example, if a user has been previously presented with monetization content 10 times (in one or more applications) in the physical goods channel and the user has purchased physical goods 4 out of the 10 times, the probability that a user will activate monetization content in the physical goods channel may be 0.4. Similarly, a user activation history may be based on a group of users such as all the users of an application. For example, if all users of the travel review application have been previously presented with monetization content 1000 times in the physical goods channel and the users purchased physical goods 240 out of the 1000 times, the probability that a user will activate monetization content in the physical goods channel may be 0.24. According to an implementation, the probability that a user will activate the presented monetization content may be received from a trained machine learning system. For example, a machine learning system may make predictions as to the likelihood that a user or group of users will activate monetization content in a particular monetization channel based on past examples of user behavior received by the system.

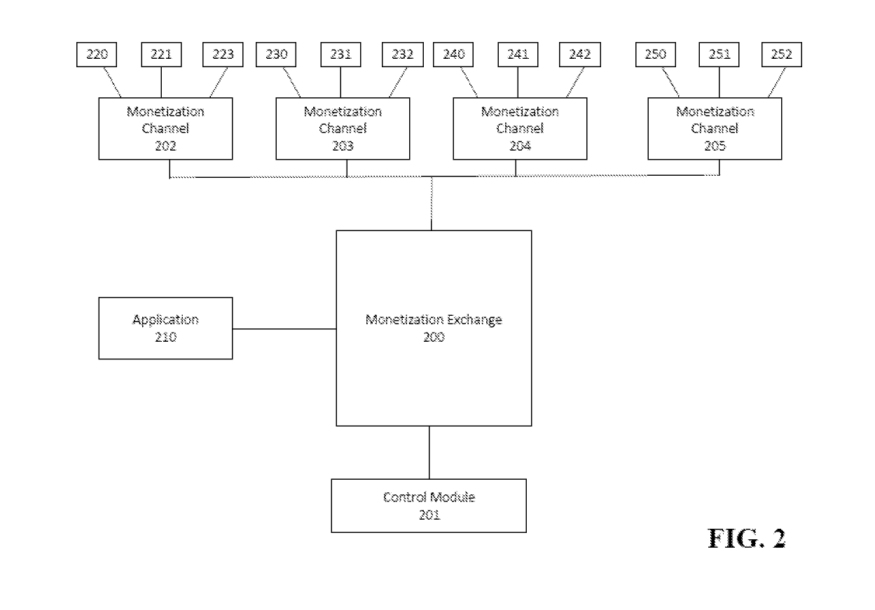

FIG. 2 shows an example system arrangement according to an implementation of the disclosed subject matter. As shown, the monetization exchange system 200 may communicate with multiple monetization channels 202, 203, 204, and 205. Although FIG. 2 only shows four different monetization channels, the monetization system 200 may communicate with any number of different monetization channels. Each of the monetization channels 202, 203, 204, and 205 may communicate with vendors of monetization content in each channel. As shown, monetization channel 202 may communicate with vendors 220, 221, and 223. Monetization channel 203 may communicate with vendors 230, 231, and 232. Monetization channel 204 may communicate with vendors 240, 241, and 242. Similarly, monetization channel 205 may communicate with vendors 250, 251, and 252. Although FIG. 2 only shows three different vendors in each monetization channel, each monetization channel may include any number of different vendors of monetization content in a channel.

The monetization exchange system 200 may also communicate with an application 210 and a control module 201. A monetization exchange system 200 may receive a request for monetization of an application 210 from a developer of the application 210. As an example, a developer of a skateboard gaming application 210 may request for monetization of the application by the monetization exchange system 200. When a developer provides an application to an application provider, the developer may also provide information about the application. The developer may provide, via the control module 201 or a frontend interface, information related to the application such as name, description, keywords, and any other information that may be used by the exchange system 200 to identify monetization content relevant to the application. The exchange system 200 may also provide an option for this information about the application to be retrieved from other systems such as an application marketplace. In some cases, this information may be retrieved from other systems such as an application marketplace and the developer may not need to re-enter all the information related to the application to the exchange system 200. This information may include keywords that may be extracted by the application provider and/or the monetization exchange system 200 and these keywords may be used by the monetization exchange system 200 to query each of the various monetization channels 202, 203, 204, and 205 for monetization content relevant to the application from the vendors 220, 221, 222, 230, 231, 232, 240, 241, 242, 250, 251, and 252. Alternatively, the monetization exchange system 200 may use any other technique for requesting monetization content relevant to an application from various monetization channels.

According to an implementation, the monetization exchange system 200 may receive an indication, from the application 210, of the availability of a monetization opportunity in the application 210. A monetization opportunity may be triggered at a certain time, event, or occurrence in the application at which monetization content may be presented to a user. For example, in the skateboard gaming application 210, a user may progress between levels, and a monetization opportunity may be available when the user is in between levels in the application 210. Similarly, a monetization opportunity may be available when the game is paused or when the user reaches a certain point or achievement in the game. In the example of a travel review application, a monetization opportunity may be available when the user views a travel topic, a travel destination, and the like, or when search results are presented to a user in response to a user's search query, and the like. Because the monetization exchange system may select a monetization channel each time a monetization opportunity is available in an application, the system may continuously optimize the revenue generated throughout the life of an application.

Upon receiving an indication from the application 210 of the availability of a monetization opportunity, the monetization exchange system 200 may identify multiple monetization channels, for example advertisements 202, in-app purchases 203, one-time downloads 204, and physical goods 205. Taking the example of a skateboard gaming application, the monetization exchange system 200 may extract the keywords “skateboard” and “extreme sports” (among other keywords) from the information provided by the developer of the skateboard gaming application 210. The monetization exchange system 200 may query each of the identified monetization channels 202, 203, 204, and 205 using the keywords “skateboard” and “extreme sports” for monetization content relevant to the skateboard gaming application 210. Table 1 below shows the respective projected revenue, probability, and score for each monetization channel. For the advertisements channel 202, vendor 220 may include an extreme sports magazine may be interested in providing an advertisement in the application 210. The system 200 may determine that the projected revenue for the application based on the advertisements channel 202 is $1. They system 200 may also determine that the probability that a user will activate an ad for the extreme sports magazine presented in the application is 0.2. For the in-app purchases channel 203, vendor 231 may provide an option to present an offer for an enhanced skateboard that may provide enhanced features while playing the game. The system 200 may determine that the projected revenue for the application based on the in-app purchases channel 203 is $3 and the probability that a user will purchase the enhanced skateboard is 0.6. For the one-time downloads channel 204, a vendor 242 may provide an option to present an offer for a user to purchase and download a snowboard gaming application made by the same developer as the skateboard gaming application. The system 200 may determine that the projected revenue for the application based on the one-time downloads channel 204 is $1 and the probability that a user will purchase and download the snowboard gaming application is 0.8. For the physical goods channel 205, vendor 251 may be a skateboard manufacturer that may be interested in presenting an offer for a user to purchase a skateboard. The system 200 may determine that the projected revenue for the application based on the physical goods channel 205 is $12 and the probability that a user will purchase the skateboard is 0.1.

TABLE 1

| Monetization | Projected | | Score (Projected |
|---|---|---|---|
| Channel | Revenue | Probability | Revenue × Probability) |
| Advertisements | $1 | 0.2 | 0.2 |
| In-app Purchases | $3 | 0.6 | 1.8 |
| One-time | $1 | 0.8 | 0.8 |
| Downloads | | | |
| Physical Goods | $12 | 0.1 | 1.2 |

As shown in Table 1 above, the monetization system 200 may generate a score for each monetization channel 202, 203, 204, and 205. For example, the system 200 may generate a score based on the projected revenue and probability for each channel. The system 200 may generate a score of 0.2 for the advertisements channel 202, a score of 1.8 for the in-app purchases channel 203, a score of 0.8 for the one-time downloads channel 204, and a score of 1.2 for the physical goods channel 205. Based on the scores for each monetization channel, the system 200 may select a monetization channel. In some cases, the system 200 may select the monetization channel with the highest score among the multiple monetization channels. For example, the system 200 may select the in-app purchases channel 203 with the highest score of 1.8 among all the identified monetization channels. The specific example provided above with respect to Table 1 is illustrative only. More generally, any suitable technique for assigning relative scores or other metrics to monetization channels may be used according to the techniques disclosed herein.

Referring back to FIG. 2, the monetization exchange system 200 may also communicate with a control module 201. According to an implementation, a developer of an application may view, monitor, manage, and/or control the monetization strategy for an application. For example, a developer may indicate that they do not wish to have monetization content in a particular monetization channel presented in their application, a developer may indicate that they do not wish to have monetization content associated with a competitor presented in their application, a developer may wish to control the maturity level of monetization content that is presented in their application, and the like. Additionally, in some cases, the monetization exchange system 200 may automatically select a monetization channel based on the score of the channel or a monetization channel may be selected based on an instruction received from a developer of the application. The control module 201 may also allow a developer to continuously monitor the revenue generated by one or more applications in the developer's portfolio. In addition, a developer may also use the control module 201 to create parametric rules for any of the steps performed by the monetization exchange system 200.

A developer may create parametric rules, for example, via the control module 201, based on which a monetization channel may be selected. For example, in addition to or as an alternative to selecting a monetization channel based on the generated score, other factors such as day of the week, time of day, revenue goals, and the like may be considered. As an example, the developer may indicate a minimum threshold score for selection of a monetization channel such that if the score for a particular channel score falls below the minimum threshold value, the monetization channel may not be selected. In the case of the skateboard example above, the developer may set a minimum threshold value of 0.50 for the score of the advertising monetization channel. In this case, if the score generated for the advertising channel is 0.30, the exchange may not select the channel, irrespective of whether it is the highest score or not among all the monetization channels. Providing a developer with the ability to indicate minimum threshold values may be particularly useful in situations in which the developer may have some pre-determined knowledge (e.g., based on past data, past performance, etc.) about the potential revenue that may be generated by each of the monetization channels. As such, the developer may want to implement a particular monetization channel, even when the score of the particular channel may be lower relative to other monetization channels. In some cases, a developer may be able to turn “on/off” a particular monetization channel that may be implemented by the monetization exchange system.

The exchange system may also provide a developer with the option to create parametric rules that may be used to select a monetization channel in addition to or as an alternative to the score for a channel. Other factors may be used to generate a score or used to select a monetization channel based on the generated score. For example, a developer may set a rule based on the day of the week. A developer may indicate for particular days of week to only implement specific monetization channels. A developer may also set goals for generating revenue in a particular monetization channel. For example, a developer may specify that they wish to implement monetization channel A until X amount of revenue is generated from channel A, then Y amount of revenue from channel B, etc. Once X amount of revenue is generated from channel A, and Y amount of revenue is generated from channel B, the system may then return to operation based on score comparison and selected as described above. By providing a developer with the ability to control and create parametric rules for implementing a monetization channel, a developer may focus the monetization strategy for an application based on particular business needs.

Under current practice, when a developer wishes to present an advertisement in an application, the code for the application may be written to include instructions for how to monetize the application, such as via a specific monetization channel, at the time the application is created. For example, conventional code for an application may include instructions to show an ad such as “show_ad( ){provide_an_ad(network)}.” According to an implementation, the disclosed monetization exchange system may be implemented for an existing application (e.g., that has been released to the public) that includes instructions within the application code to monetize the application via a specific monetization channel. As an example, an application code may include an instruction to show an ad such as “show_ad( ){provide_an_ad(network)}.” Based on this instruction, an indication may be received at the advertisement channel, from the application, of the availability of a monetization opportunity in the application. Rather than present monetization content to the application from the advertisement channel, the indication of the availability of a monetization opportunity in the application may be re-routed to the monetization exchange system.

Re-routing of a request for specific monetization content from an application may be performed by creating a rule at an advertisement server (e.g., advertisements monetization channel) indicating that all monetization content requests that are received directly from applications (e.g., via the DNS) should be re-routed to the monetization exchange system. For example, rerouting of a request to an existing advertising monetization channel may be performed by updating information associated with the advertising channel server (e.g., servername-IP) in the DNS to point to the server info of the monetization exchange system. In this case, all requests sent to the advertising monetization channel server may be re-routed to the monetization exchange system server. As a result, changes to the advertising monetization channel server may not be necessary. The monetization exchange system server may be configured to accept a method call such as “show_add( ){provide_an_ad(network)}.” In this case, the monetization exchange system may either default the selection of the monetization channel to the advertising channel (e.g., as an initial default option, allowing the developer to change this default setting via the control module) or the method call may be acted upon as though the method call “monetize( ){allow_exchange_select( ){ }” were received. As a result, the monetization exchange system may select an appropriate monetization channel using the techniques described herein. In some cases, this re-routing technique may occur automatically for all monetization content requests that are received, from applications, directly at a monetization channel. Additionally, a notification may be provided to a developer of an application for which requests for monetization content may be re-routed. In this case, the developer may control, via the control module, whether or not the specific monetization content requests should be re-routed to the monetization exchange system. By re-routing a request for specific monetization content based on an instruction included in an application code at the time the application was released, the monetization exchange system described herein may be implemented for existing applications.

In some cases, a developer of an application that has been released and in which the application code includes an instruction to present specific monetization content (e.g., “show_ad( ){provide_an_ad(network)}”, the developer may wish to implement the monetization exchange system for the application. In this case, the portion of the application code that provides an instruction to present specific monetization content, e.g., “show_ad( ){provide_an_ad(network)}” may be updated to “monetize( ){allow_exchange_select( ){ }.” This update to the application code may be provided to all devices on which the application is currently installed. As a result, the monetization exchange system may implement a monetization channel for a monetization opportunity in the application using the techniques described herein. Following the update to the application, a user of the application may notice that monetization content presented in the application may include, in addition to advertisements, other monetization content such as in-app downloads, physical goods, one-time downloads, and the like, whereas prior to the update, only advertisements may have been presented. By allowing a developer to update the code for an application to replace a request for specific monetization content with a request to use the monetization exchange system, the monetization exchange system described herein may be implemented for existing applications.

Once a monetization channel is selected, either automatically by the system 200 or based on an instruction received from the developer via the control module 201, the selected monetization channel may be implemented for the application. A monetization channel may be implemented for an application in a variety of ways. Implementing a selected monetization channel may include providing, to the application 210, monetization content based on the selected monetization channel. According to an implementation, implementing a selected monetization channel may include providing, to a vendor in the selected monetization channel, a request for monetization content for a monetization opportunity in the application. The system 200 may receive monetization content from the vendor and may present the monetization content to a user of the application 210. As another example, implementing a selected monetization channel may include presenting, to a user of the application, monetization content based on the selected monetization channel. In the skateboard gaming application example above, the selected in-app purchases channel may be implemented by presenting an offer for an enhanced skateboard that may provide enhanced features while playing the game to the user of the application. As another example, implementing a selected monetization channel may include displaying an interface associated with the selected monetization channel. In this case the interface may present monetization content in the selected monetization channel to a user of the application. In some cases, the interface may provide action items to a user such as the ability to purchase and/or download content or purchase physical goods.

As discussed above, a probability used to generate a score for a monetization channel may be based on a user history for a particular user or a user history for a group of users of an application. Similarly, presentation of monetization content in an application may be implemented for all users of an application such that all of users of a particular application are presented with the same monetization content. In some cases, presentation of monetization content in an application may be implemented for each individual user of an application such that each user of a particular application is presented with the monetization content that is customized based on the user's activation history.

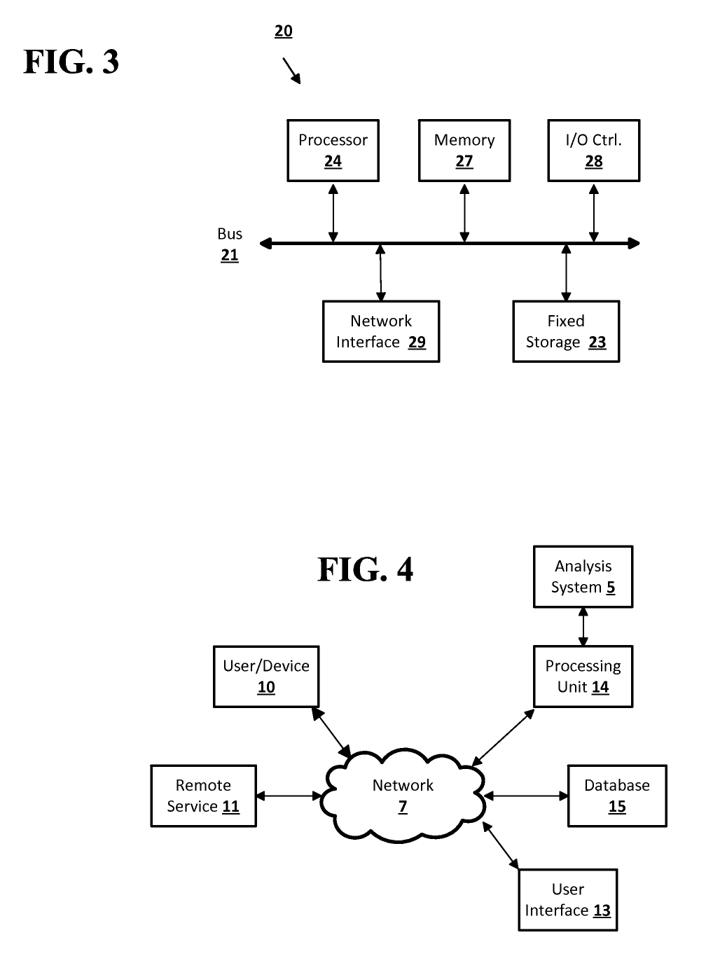

Embodiments of the presently disclosed subject matter may be implemented in and used with a variety of component and network architectures. FIG. 3 is an example computer system 20 suitable for implementing embodiments of the presently disclosed subject matter. The computer 20 includes a bus 21 which interconnects major components of the computer 20, such as one or more processors 24, memory 27 such as RAM, ROM, flash RAM, or the like, an input/output controller 28, and fixed storage 23 such as a hard drive, flash storage, SAN device, or the like. It will be understood that other components may or may not be included, such as a user display such as a display screen via a display adapter, user input interfaces such as controllers and associated user input devices such as a keyboard, mouse, touchscreen, or the like, and other components known in the art to use in or in conjunction with general-purpose computing systems.

The bus 21 allows data communication between the central processor 24 and the memory 27. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as the fixed storage 23 and/or the memory 27, an optical drive, external storage mechanism, or the like.

Each component shown may be integral with the computer 20 or may be separate and accessed through other interfaces. Other interfaces, such as a network interface 29, may provide a connection to remote systems and devices via a telephone link, wired or wireless local- or wide-area network connection, proprietary network connections, or the like. For example, the network interface 29 may allow the computer to communicate with other computers via one or more local, wide-area, or other networks, as shown in FIG. 4.

Many other devices or components (not shown) may be connected in a similar manner, such as document scanners, digital cameras, auxiliary, supplemental, or backup systems, or the like. Conversely, all of the components shown in FIG. 3 need not be present to practice the present disclosure. The components can be interconnected in different ways from that shown. The operation of a computer such as that shown in FIG. 3 is readily known in the art and is not discussed in detail in this application. Code to implement the present disclosure can be stored in computer-readable storage media such as one or more of the memory 27, fixed storage 23, remote storage locations, or any other storage mechanism known in the art.

FIG. 4 shows an example arrangement according to an embodiment of the disclosed subject matter. One or more clients 10, 11, such as local computers, smart phones, tablet computing devices, remote services, and the like may connect to other devices via one or more networks 7. The network may be a local network, wide-area network, the Internet, or any other suitable communication network or networks, and may be implemented on any suitable platform including wired and/or wireless networks. The clients 10, 11 may communicate with one or more computer systems, such as processing units 14, databases 15, and user interface systems 13. In some cases, clients 10, 11 may communicate with a user interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to web browser clients 10, and a computer-readable API or other interface is provided to remote service clients 11. The user interface 13, database 15, and processing units 14 may be part of an integral system, or may include multiple computer systems communicating via a private network, the Internet, or any other suitable network. Processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as CD-ROMs, DVDs, hard drives, USB (universal serial bus) drives, flash drives, or any other non-transitory machine readable storage medium, such that when the computer program code is loaded into and executed by a computer, the computer becomes an apparatus for practicing embodiments of the disclosed subject matter. Embodiments also may be embodied in the form of computer program code, for example, whether stored in a non-transitory storage medium, loaded into and/or executed by a computer. When the computer program code is loaded into and executed by a computer, the computer becomes an apparatus for practicing embodiments of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information, as previously described. The memory or other storage medium may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method comprising:
identifying a plurality of monetization channels;
determining a projected revenue for an application based on each of the plurality of monetization channels;
generating a score for each channel of the plurality of monetization channels based on the projected revenue for the channel;
selecting a first monetization channel of the plurality of monetization channels based on the score of the first monetization channel; and
implementing the first monetization channel for the application.

2. The method of claim 1, further comprising receiving an indication, from the application, of the availability of a monetization opportunity in the application.

3. The method of claim 1, wherein each of the plurality of monetization channels is selected from the group consisting of: advertisements, in-app purchases, one-time downloads, and physical goods.

4. The method of claim 1, wherein the projected revenue for an application is an expected dollar amount received by a developer of the application upon activation, by a user, of monetization content based on the channel, presented by the application to the user.

5. The method of claim 1, wherein the score for each channel of the plurality of channels is based on a probability that a user will activate presented monetization content in the channel.

6. The method of claim 1, wherein the score for each channel of the plurality of channels is a product of the projected revenue for the channel and a probability that a user will activate presented monetization content based on the channel.

7. The method of claim 5, wherein the probability that a user will activate the presented monetization content is based on a user activation history associated with a user.

8. The method of claim 7, wherein the probability that a user will activate the presented monetization content is received from a trained machine learning system.

9. The method of claim 1, wherein the first monetization channel has the highest score among the plurality of monetization channels.

10. The method of claim 1, wherein implementing the first monetization channel comprises displaying an interface associated with the first monetization channel.

11. The method of claim 1, wherein implementing the first monetization channel comprises presenting, to a user of the application, monetization content based on the first monetization channel.

12. The method of claim 1, wherein implementing the first monetization channel comprises providing, to the application, monetization content based on the first monetization channel.

13. The method of claim 1, wherein implementing the first monetization channel comprises providing, to a vendor in the selected monetization channel, a request for monetization content for a monetization opportunity in the application; receiving monetization content; and presenting the monetization content to a user of the application.

14. The method of claim 1, further comprising receiving a request for monetization from a developer of the application.

15. The method of claim 1, wherein selecting a first monetization channel is further based on an instruction received from a developer of the application.

16. A system comprising:
a processor configured to:
identify a plurality of monetization channels;
determine a projected revenue for an application based on each of the plurality of monetization channels;
generate a score for each channel of the plurality of monetization channels based on the projected revenue for the channel;
select a first monetization channel of the plurality of monetization channels based on the score of the first monetization channel; and
implement the first monetization channel for the application.

17. The system of claim 16, wherein the processor is further configured to receive an indication, from the application, of the availability of a monetization opportunity in the application.

18. The system of claim 16, wherein each of the plurality of monetization channels is selected from the group consisting of: advertisements, in-app purchases, one-time downloads, and physical goods.

19. The system of claim 16, wherein the projected revenue for an application is an expected dollar amount received by a developer of the application upon activation, by a user, of monetization content in the channel, presented by the application to the user.

20. The system of claim 16, wherein the score for each channel of the plurality of channels is based on a probability that a user will activate monetization content in the channel.

21. The system of claim 16, wherein the score for each channel of the plurality of channels is a product of the projected revenue for the channel and a probability that a user will activate presented monetization content in the channel.

22. The system of claim 20, wherein the probability that a user will activate presented monetization content is based on a user activation history associated with a user.

23. The system of claim 22, wherein the probability that a user will activate the presented monetization content is received from a trained machine learning system.

24. The system of claim 16, wherein the first monetization channel has the highest score among the plurality of monetization channels.

25. The system of claim 16, wherein implementing the first monetization channel comprises displaying an interface associated with the first monetization channel.

26. The system of claim 16, wherein implementing the first monetization channel comprises presenting, to a user of the application, monetization content based on the first monetization channel.

27. The system of claim 16, wherein implementing the first monetization channel comprises providing, to the application, monetization content based on the first monetization channel.

28. The system of claim 16, wherein the processor is further configured to receive a request for monetization from a developer of the application.

29. The system of claim 16, wherein implementing the first monetization channel comprises providing, to a vendor in the selected monetization channel, a request for monetization content for a monetization opportunity in the application; receiving monetization content; and presenting the monetization content to a user of the application.

30. The system of claim 16, wherein selecting a first monetization channel is further based on an instruction received from a developer of the application.
